(19) United States
(12) Patent Application Publication
(10) Pub. No.: US 2002/0021812 A1
(43) Pub. Date: Feb. 21, 2002

(54) Loudspeaker

(76) Inventor: Graham Bank, Suffolk (GB)

Correspondence Address: Alan I. Cantor, FOLEY & LARDNER, Washington Harbour, 3000 K. Street, Suite 500, Washington, DC, 20007-5109, US

(21) Appl. No.: 09/927,577

(22) Filed: Aug. 13, 2001

Related U.S. Application Data
(60) Provisional application No. 60/224,505, filed on Aug. 14, 2000.

(30) Foreign Application Priority Data
Aug. 11, 2000 (GB) 0019701.2

(51) Int. Cl. H04R 25/00

(52) U.S. Cl. 381/152; 381/431

(57) ABSTRACT

A loudspeaker comprising a panel capable of supporting bending waves and at least two exciters mounted to the panel for exciting bending waves in the panel to produce an acoustic output, each of the exciters being adapted for connection to respective independent sources of drive signals. A loudspeaker system and a method for operating it also are disclosed. The loudspeaker and system are useful, e.g., as a sound-generating ceiling tile.

This application claims the benefit of U.S. provisional No. 60/224,505, filed Aug. 14, 2000.

### FIELD OF THE INVENTION

The invention relates to a loudspeaker and, in particular, to a loudspeaker that uses a plurality of different exciters.

### BACKGROUND ART

Bending wave panel loudspeakers are known, for example from WO97/09842 and counterpart U.S. application Ser. No. 08/707,012, filed Sep. 3, 1996, both to New Transducers Ltd. In general, such speakers include a resonant bending wave plate and a transducer mounted on the plate to convert electrical signals into mechanical vibrations. The transducer excites the resonant bending wave modes in the plate, which then emit sound to create an acoustic output.

The properties of the acoustic radiator may be chosen to distribute the resonant bending wave modes substantially evenly in frequency. In other words, the properties or parameters, e.g. size, thickness, shape, material etc., of the acoustic radiator may be chosen to smooth peaks in the frequency response caused by “bunching” or clustering of the modes. The resultant distribution of resonant bending wave modes may thus be such that there are substantially minimal clusterings and disparities of spacing.

In particular, the properties of the acoustic radiator may be chosen to distribute the lower frequency resonant bending wave modes substantially evenly in frequency. The number of resonant bending wave modes is fewer at lower frequencies than at higher frequencies and thus the distribution of the lower frequency resonant bending wave modes is particularly important. The lower frequency resonant bending wave modes are preferably the ten to twenty lowest frequency resonant bending wave modes of the acoustic radiator. The resonant bending wave modes associated with each conceptual axis of the acoustic radiator may be arranged to be interleaved in frequency. Each conceptual axis has an associated lowest fundamental frequency (conceptual frequency) and higher modes at spaced frequencies. By interleaving the modes associated with each axis, the substantially even distribution may be achieved. There may be two conceptual axes and the axes may be symmetry axes. For example, for a rectangular acoustic radiator, the axes may be short and long axes parallel to the short and long sides of the acoustic radiator, respectively. For an elliptical acoustic radiator, the axes may correspond to the major and minor axes of the ellipse. The axes may be orthogonal.

The transducer location may be chosen to couple substantially evenly to the resonant bending wave modes. In particular, the transducer location may be chosen to couple substantially evenly to lower frequency resonant bending wave modes. In other words, the transducer may be mounted at a location spaced away from nodes (or dead spots) of as many lower frequency resonant modes as possible. Thus the transducer may be at a location where the number of vibrationally active resonance anti-nodes is relatively high and, conversely, the number of resonance nodes is relatively low. Any such location may be used, but the most convenient locations for rectangular panels are the near-central locations between 38% to 62% along each of the length and width axes of the panel, but off-central. Specific locations found suitable are at 3/7, 4/9 or 5/13 of the distance along the axes; a different ratio for the length axis and the width axis is preferred.

A bending panel loudspeaker in the form of a ceiling tile is known from WO97/09843 and U.S. Pat. No. 6,215,881, both to New Transducers Ltd. It is also known from WO97/09846 and U.S. Pat. No. 6,031,926, likewise to New Transducers Ltd., to provide a bending panel loudspeaker with multiple exciters connected in parallel to an amplifier. Loudspeaker systems capable of broadcasting alarm signals, white noise to enhance privacy in an open plan office, and music or speech are known; however, each signal source requires its own loudspeaker adapted to the particular signal to be broadcast. The present invention addresses the increased cost and space implications of such known systems.

### SUMMARY OF THE INVENTION

Accordingly, the present invention is directed to a loudspeaker comprising a panel capable of supporting bending waves and at least two exciters mounted to the panel for exciting bending waves in the panel to produce an acoustic output, each of the exciters being adapted for connection to respective independent sources of drive signals.

The use of a single panel to support the exciters for two different signal sources significantly reduces the space requirements of the system as a whole as well as reducing the overall cost of the system. This is made possible by the bending mode operation of the panel which allows faithful reproduction of multiple excitation signals when applied simultaneously to the panel.

The invention also comprises a ceiling tile and a loudspeaker system incorporating such a loudspeaker.

The invention further concerns a method of operating a loudspeaker having a panel capable of supporting bending waves and at least two exciters mounted to the panel for exciting bending waves in the panel to produce an acoustic output, comprising driving each of the exciters by an independent source of drive signals. The loudspeaker may have three exciters, one of the exciters being selectively driven such that the panel produces an alarm signal, another of the exciters being selectively driven such that the panel produces a signal conditioning signal, and the last of the exciters being selectively driven such that the panel produces an audio signal in the form of music and/or speech.

### BRIEF DESCRIPTION OF THE DRAWING

For a better understanding of the invention a specific embodiment will now be described with reference to the accompanying drawing FIGURE, which is a perspective view of a ceiling tile loudspeaker according to the invention.

### DETAILED DESCRIPTION

A panel 1 shaped as a conventional ceiling tile has opposed top 3 and bottom 5 faces. The bottom face is intended to face into a room when the ceiling tile is fitted. The panel is capable of supporting resonant bending waves and the panel parameters are selected for a useful distribution of bending wave resonances in frequency, for example as taught in the aforementioned WO97/09842 and U.S. counterpart application Ser. No. 08/707,012, filed Sep. 3, 1996 (the latter being incorporated herein by reference).

Such a panel is available, for example, from HONIPAN and comprises a core of aluminium honeycomb skinned on either side by Kraft paper and having a total thickness of 7 mm. The anisotropic properties of the Kraft paper result in a panel in which the modal distributions are different for the two conceptual axes in spite of the panel itself having a square plan geometry (59.5 cm×59.5 cm in the present example).

Three exciters 7,9,11 are mounted on the top face 3 of the panel. Exciter 7 is an alarm exciter for producing an alarm signal in a predetermined frequency band. Such a signal preferably has a sound pressure level of more than 90 dB—in particular 100 dB±5 dB SPL (Sound Pressure Level)—at 1W, 1 m. In a narrow frequency band around the predetermined alarm frequency, the level may exceed 100 dB SPL.

To achieve this degree of power delivery into the panel, an exciter may be used having a voice coil with a high maximum current, or an exciter that delivers a high force to the panel for a given current or voltage input. Such an exciter is of the moving coil type manufactured, for example, by ELAC Elektroakustik, Germany and having a 37 mm diameter voice coil and an operating bandwidth of 150 Hz-10 kHz.

Exciter 7 is coupled to the panel at a location that couples well to the resonant bending wave mode or modes at the predetermined frequency, as discussed above with regard to WO97/09842 and U.S. Ser. No. 08/707,012. In the panel of the example, a preferential location on the panel top surface 3 is at 36.6 cm and 25.4 cm respectively relative to adjacent orthogonal edges of the panel.

A cable 8 electrically connects exciter 7 to alarm circuit 21 capable of providing the typical 20V operating voltage required by alarm exciters of the kind described above.

A signal conditioning exciter 9 is mounted on the panel for producing a signal conditioning signal, e.g. white noise to enhance privacy in an open plan office. The maximum frequency bandwidth required for signal conditioning is much greater than that required for an alarm signal. Consequently, the location of the signal conditioning exciter 9 is chosen so as to couple with a broader frequency band of resonant bending wave modes. As explained above, such a location has a relatively high number of vibrationally active resonance anti-nodes together with a relatively low number of resonance nodes. In the panel of the example, this location is at 36.6 cm and 33.1 cm respectively relative to adjacent orthogonal edges of the panel.

The exciter 9 itself also requires a broad frequency range, albeit at a different maximum sound pressure level to that of the alarm exciter (preferably 70 dB to 90 dB SPL, more preferably 90 dB±5 dB SPL). In the present example, these requirements are met by a moving coil exciter having a 25 mm diameter voice coil of the kind manufactured by Zhejiang Tianle Group Corp., China. Such a device has an operating bandwidth of 80 Hz to 18 kHz and an input voltage of 10V which is supplied via cable 10 from a signal conditioning driver 20 which operates independently from alarm circuit 21.

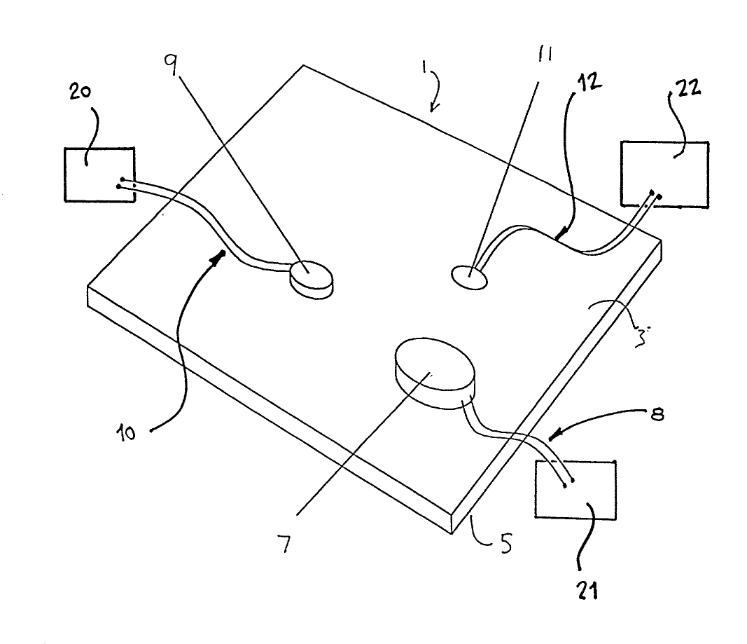

Reference FIG. 11 indicates a third, background music exciter 11 mounted to the panel top surface 3. Since this exciter is intended for reproducing an audio signal, the quality of the signal output from this exciter generally needs to be highest. Consequently, the exciter may be coupled at the best available location or site for coupling to a broad frequency band of resonant bending wave modes, with the white noise exciter 9 being coupled at a worse location and the location of the alarm exciter 7 giving coupling over a yet narrower frequency band. In the present example, the best available location is at 26.4 cm and 25.4 cm respectively relative to adjacent orthogonal edges of the panel.

At 80 dB to 100 dB SPL, preferably 90 dB±5 dB SPL, the power requirement of the background music exciter 11 lies between that of the two other exciters. It is met in the example by a simple piezoelectric exciter having a typical operating bandwidth of 300 Hz to 20 kHz and connected via a cable 12 to a driving source 22 of background music, speech, etc. which operates independently of the aforementioned alarm and signal conditioning circuits 21,20.

It will be appreciated that the present invention is not limited by what has been particularly shown or described—rather the scope of the present invention is defined only by the claims that follow.

For example, one or more of the exciters may be mounted in a recess in the panel rather than on the top face. Similarly, one or more of the exciters may be not be mounted directly on the panel but coupled to it by a coupling member.

Nor is the invention restricted to three exciters: for example, the signal conditioning exciter and the music exciter may be combined since the required bandwidth and efficiency are similar. Alternatively, a further exciter optimised to produce clear speech may be included in the panel.

1. A loudspeaker comprising a panel capable of supporting bending waves and at least two exciters mounted to the panel for exciting bending waves in the panel to produce an acoustic output, each of said exciters being adapted for connection to respective independent sources of drive signals.

2. A loudspeaker according to claim 1, wherein each of said exciters is capable of generating a maximum sound pressure level, the maximum sound pressure levels being different.

3. A loudspeaker according to claim 2, wherein each of said exciters is capable of generating sound across a maximum frequency bandwidth, the maximum frequency bandwidth of one of the exciters being greater than that of the other exciter(s).

4. A loudspeaker according to claim 3, wherein a first of said exciters is mounted on said panel at a location having a higher number of vibrationally-active resonance anti-nodes than the location at which the other exciter(s) is/are mounted.

5. A loudspeaker according to claim 4, comprising first, second and third exciters, wherein said third exciter is capable of generating sound across a maximum frequency bandwidth less than that of said second exciter, said third exciter being mounted on said panel at a location having a lower number of vibrationally active resonance anti-nodes than the location at which said second exciter is mounted.

6. A loudspeaker according to claim 1, wherein each of said exciters is capable of generating sound across a maximum frequency bandwidth, the maximum frequency bandwidth of one of the exciters being greater than that of the other exciter(s).

7. A loudspeaker according to claim 6, wherein a first of said exciters is mounted on said panel at a location having a higher number of vibrationally-active resonance anti-nodes than the location at which the other exciter(s) is/are mounted.

8. A loudspeaker according to claim 7, comprising first, second and third exciters, wherein said third exciter is capable of generating sound across a maximum frequency bandwidth less than that of said second exciter, said third exciter being mounted on said panel at a location having a lower number of vibrationally active resonance anti-nodes than the location at which said second exciter is mounted.

9. A loudspeaker according to any one of claims 1-8, adapted for installation and operation as a ceiling tile.

10. A loudspeaker system comprising a panel capable of supporting bending waves, a plural number of exciters mounted to the panel for exciting bending waves in the panel to produce an acoustic output, and the same plural number of independent sources of drive signals, each of said independent sources of drive signals being connected to respective ones of said exciters, whereby each of said exciters is separately driven.

11. A loudspeaker system according to claim 10, wherein each of said exciters is capable of generating a maximum sound pressure level, the maximum sound pressure levels being different.

12. A loudspeaker system according to claim 11, wherein each of said exciters is capable of generating sound across a maximum frequency bandwidth, the maximum frequency bandwidth of one of the exciters being greater than that of the other exciter(s).

13. A loudspeaker system according to claim 12, wherein a first of said exciters is mounted on said panel at a location having a higher number of vibrationally-active resonance anti-nodes than the location at which the other exciter(s) is/are mounted.

14. A loudspeaker system according to claim 13, comprising first, second and third exciters, wherein said third exciter is capable of generating sound across a maximum frequency bandwidth less than that of said second exciter, said third exciter being mounted on said panel at a location having a lower number of vibrationally active resonance anti-nodes than the location at which said second exciter is mounted.

15. A loudspeaker according to claim 10, wherein each of said exciters is capable of generating sound across a maximum frequency bandwidth, the maximum frequency bandwidth of one of the exciters being greater than that of the other exciter(s).

16. A loudspeaker according to claim 15, wherein a first of said exciters is mounted on said panel at a location having a higher number of vibrationally-active resonance anti-nodes than the location at which the other exciter(s) is/are mounted.

17. A loudspeaker according to claim 16, comprising first, second and third exciters, wherein said third exciter is capable of generating sound across a maximum frequency bandwidth less than that of said second exciter, said third exciter being mounted on said panel at a location having a lower number of vibrationally active resonance anti-nodes than the location at which said second exciter is mounted.

18. A method of operating a loudspeaker having a panel capable of supporting bending waves and at least two exciters mounted to the panel for exciting bending waves in the panel to produce an acoustic output, comprising driving each of the exciters by an independent source of drive signals.

19. A method according to claim 18, wherein the loudspeaker has three exciters, one of the exciters is selectively driven such that the panel produces an alarm signal, another of the exciters is selectively driven such that the panel produces a signal conditioning signal, and the last of the exciters is selectively driven such that the panel produces an audio signal in the form of music and/or speech.
